(19) United States
(12) Patent Application Publication
(10) Pub. No.: US 2007/0070615 A1
(43) Pub. Date: Mar. 29, 2007

(54) Dispensing apparatus with LED illuminated display panels

(75) Inventors: Daniel F. Joslin, New Milford, CT (US); Judy Priolo, White Plains, NY (US); Nina B. Tarley, Monsey, NY (US); John Reiches, New Rochelle, NY (US)

Correspondence Address: PEPSICO, INC.;c/o GOODWIN PROCTER LLP, 599 LEXINGTON AVE, NEW YORK, NY, 10022, US

(73) Assignee: PepsiCo, Inc.

(21) Appl. No.: 11/238,398

(22) Filed: Sep. 29, 2005

(51) Int. Cl. F21V 33/00

(52) U.S. Cl. 362/92

(57) ABSTRACT

A device such as a vending machine, merchandiser or beverage dispenser for dispensing a number of products. The device includes one or more display panels illuminated by a light emitting diode (LED) or an array of LED's positioned to backlight the display panels.

### BACKGROUND OF THE INVENTION

1. Technical Field

The present invention relates generally to a dispensing apparatus such as a vending machine, cooler, beverage dispenser, merchandiser, display rack or the like, with one or more illuminated display panels, and more particularly to a dispensing apparatus with a light emitting diode (LED)-illuminated display panel.

2. Background Art

Vending machines, coolers, refrigerated merchandisers and fountain-type dispensers for products such as soft drinks are typically provided with translucent display panels for advertising and decoration. In the case of vending machines, these panels may be located on the front and/or sides of the machine, and may bear depictions of the products, brand names, slogans and other indicia. Refrigerated coolers and merchandisers and fountain-type beverage dispensers also typically have a sign or display panel, for example, at the top. Likewise, non-refrigerated merchandisers and display racks for other types of products may also have illuminated signs or display panels. These display panels may be constructed from a durable material such as Lexan and be decorated with suitable indicia. The panels are back lighted, that is, illuminated from a light source located behind them in an interior portion of the vending machine or cooler cabinet.

Typically the light source for illuminating the display panels is one or more fluorescent lamps, for example, of the 48-inch T-8 type. Although fluorescent lamps generally use less energy, operate cooler and exhibit longer life than incandescent bulbs, they still consume substantial amounts of electricity for the amount of light produced, and require expensive ballast assemblies. They also require replacement on a regular basis to assure the desired level of light output.

### SUMMARY OF THE INVENTION

It is a feature of the invention to provide a system for illuminating a display panel on a dispensing apparatus with an energy-efficient LED light source.

It is a further feature of the invention to provide a system for illuminating a display panel on a dispensing apparatus with a long-life LED light source which requires less maintenance than conventional light sources.

It is still another feature of the invention to provide a system for illuminating a display panel on a dispensing apparatus with an LED light source which provides an attractive and pleasing appearance that enhances the advertisement and merchandising of the products.

It is yet another feature of the invention to provide a system for illuminating a display panel on a dispensing apparatus with an LED light source in which the color and intensity of the lighting can be varied to further enhance the advertisement and merchandising of the products.

Accordingly, the invention contemplates an improved design for a dispensing apparatus using light emitting diodes (LED's) to illuminate display panels thereon. The rapid development of high brightness LED's provides an opportunity for energy savings, longer life, reduced maintenance and more aesthetically appealing lighting for vending machines, coolers, beverage dispensers and the like. LED's consume substantially less energy than conventional incandescent and fluorescent lamps. LED's also have very long life spans, operating for as long as ten years or longer without failing. Indeed, the LED's can be expected to last as long as the vending machine, cooler, or dispenser itself. LED's are also smaller in size than fluorescent lamps and may be conveniently mounted in various ways. High-brightness LED's provide a bright, aesthetically attractive light which fully illuminates the display. Further, LED's are available in a range of colors, allowing the display to include a variable color feature to catch the eye of consumers.

### BRIEF DESCRIPTION OF THE DRAWINGS

FIG. 1 is a front perspective view of a vending machine having the LED-back lighted display panel of the invention.

FIG. 2 is a front perspective view of the vending machine of FIG. 1 with the front door panel opened, providing a view of the interior of the machine.

FIG. 3 is a perspective view of an LED lighting strip for use with the invention.

FIG. 4 is a front view of a glass front cooler having the LED-back lighted display panel of the invention.

FIG. 5 is a side view of the cooler of FIG. 4.

FIG. 6 is a front perspective view of a beverage dispenser having the LED-back lighted display panel of the invention.

FIG. 7 is a view of an LED matrix mounted on a circuit board.

### DETAILED DESCRIPTION

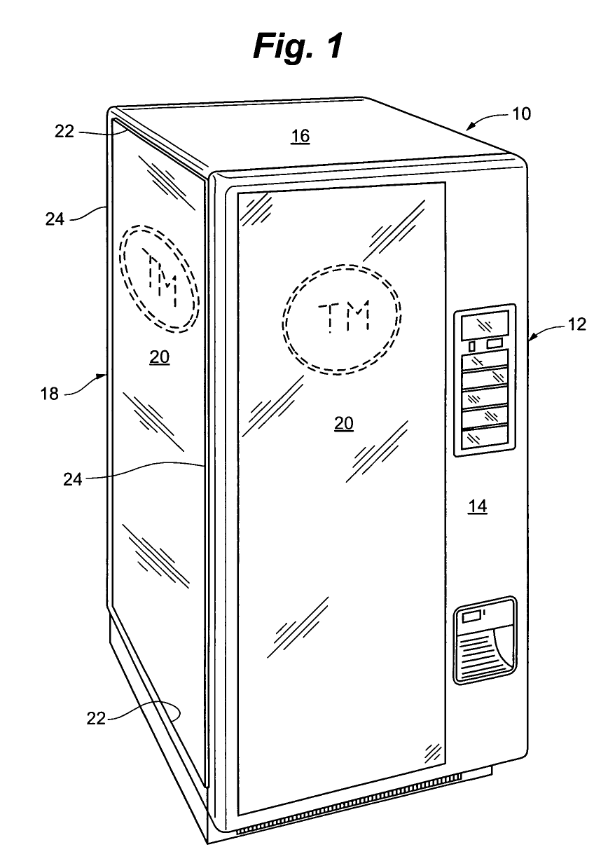

The dispensing device may include any type of cabinet or enclosure suitable for the type of products to be dispensed. In the embodiment shown in FIG. 1, the dispensing device is a vending machine 10 of the type which may dispense soft drinks or other beverages in bottles or cans. Front selection panel 12 includes on its front surface 14 an appropriate coin and/or bill handling mechanism, product selection buttons, and a product dispenser. The top panel 16, rear panel (not shown) and side frames 18 of the vending machine 10 are typically constructed primarily of sheet metal, although other suitable materials may be used.

At least one display panel 20 is mounted on the machine 10. As shown in FIG. 1, a display panel 20 is provided on at least the front, and preferable may also be provided on one or both sides, of the machine 10. The display panels 20 may be decorated with trademark or product identification indicia, pictures of the products sold by the machine, or other graphics, aesthetic decorations or designs. The display panels 20 may be formed of any suitable transparent or translucent material, typically plastic, and may be constructed of a strong, impact-resistant material such as Lexan to withstand use in outdoor locations, vandalism and the like. A large, single-sheet construction of the display panels 20 as shown in FIG. 1 provides maximum display area and allows for simple on-site replacement of the panels, either to replace a damaged panel or to update the graphics.

The side display panels 20 may be held in place by a detachable frame formed from top and bottom members 22 which overlap the top and bottom edges, respectively, of side display panel 20, and side members 24 which overlap the two vertical sides of display panel 20. Members 22 and 24 may be attached to sides 18 of the machine 10 by screws or other suitable fasteners.

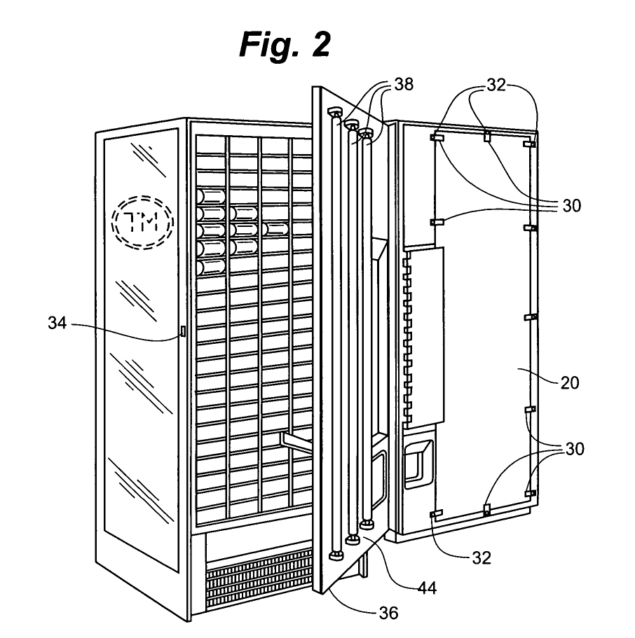

As shown in FIG. 2, the front panel of machine 10 is attached by a hinge to form a door for the vending machine. Front display panel 20 is positioned in a large rectangular opening in the sheet metal door and may be held in place by clips 30. A screw 32 holds each clip 30 in position and permits easy removal of a clip when replacement of a front display panel 20 is required.

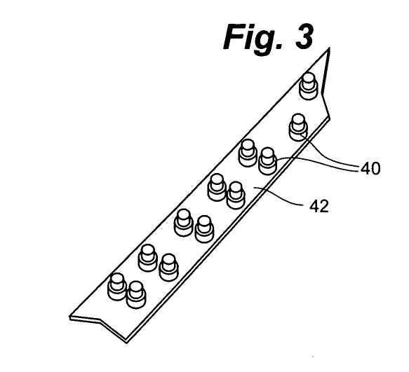

Preferably, an illumination panel 36 is provided behind front display panel 20. Illumination panel 36 is also hinged to provide access to the interior of the vending machine for loading and reloading the machine with products to be dispensed. One or more linear LED arrays 38 are mounted on panel 36 to illuminate translucent front panel 20 from the rear. LED arrays 38 each consist of a plurality of individual LED's which may be mounted within a clear glass or plastic tube as shown in FIG. 2. The individual LED's may also be arranged in a tube-like bundle without a glass or plastic tube. Alternately, an LED strip of the type shown in FIG. 3 may be used. The strip consists of a plurality of discrete LED's 40 mounted on a long narrow substrate 42. As yet another alternative, LED lamps are commercially available with an Edison-type screw base for mounting in conventional sockets of the type used for incandescent bulbs. These screw base lamp assemblies may contain built-in power supplies.

LED arrays 38 preferably comprise high brightness LED's. In some embodiments of the invention, LED's of various colors may be included in one or more of LED arrays 38, and separately controlled to permit various color effects on the display panel 20.

The surface 44 of illumination panel 36 behind LED arrays 38 may be covered with a reflective paint or material to direct more light toward the display panel 20.

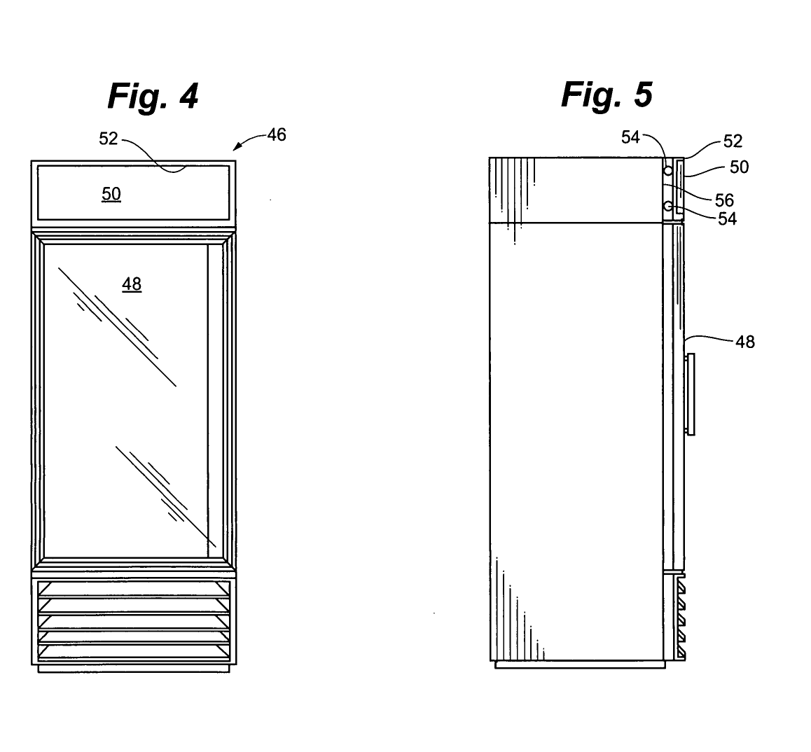

As shown in FIG. 4, the dispensing apparatus may be a self-service cooler 46, commonly known in the industry as a glass front merchandiser or Visi-cooler. Coolers of this type are widely used in super markets, convenience stores, restaurants and other retail outlets. Cooler 46 includes a refrigerated compartment for holding products to be dispensed, with a large glass door 48 that allows consumers to view the products inside. Typically, a display panel 50 is provided at the top of the cooler 46 and is mounted in frame 52. Display panel 50 may be decorated with trademark or product identification indicia, pictures of the products sold by the machine, or aesthetic decorations. Display panel 50 may be formed of any suitable transparent or translucent material, typically plastic. Display panel 50 may be readily removed from frame 52 for replacement of a damaged display panel or updating of graphics.

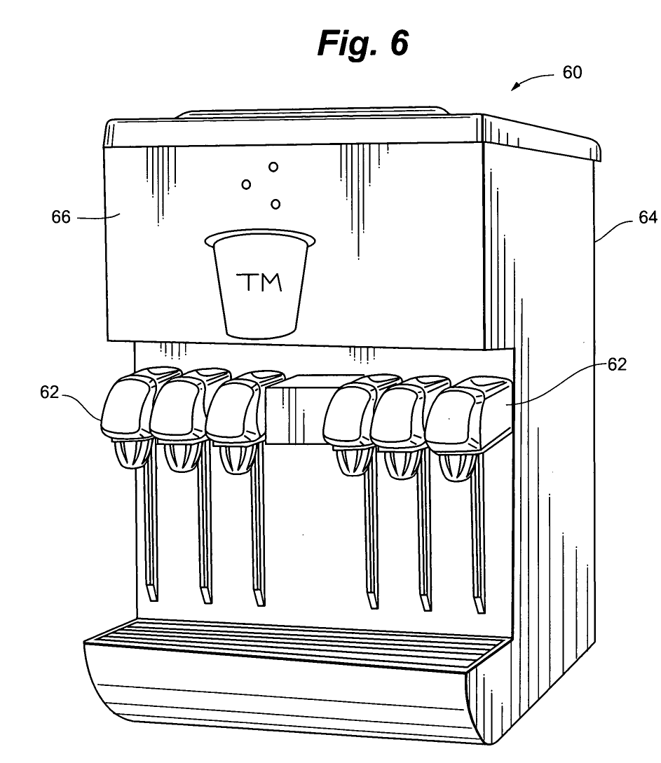

As shown in FIG. 5, LED arrays 54 are positioned behind panel 50 to illuminate panel 50 by back lighting. A reflector 56 may be provided behind LED arrays 54 to direct more light toward the back of display panel 50. LED arrays 54 may be elongated tube-like bundles of individual LED's, or other LED arrays as previously described.

FIG. 6 illustrates a fountain-type beverage dispenser 60 using the LED-illuminated display panel of the invention. Beverage dispenser 60 includes individual beverage dispensing heads 62 mounted to a housing 64. Display panel 66 is provided at the top of beverage dispenser 60. Display panel 66 may be formed of any suitable transparent or translucent material, typically plastic, and includes trademark or other product identification indicia, decorative designs, or graphics. LED arrays are mounted within housing 64 to backlight display panel 66 in the same manner as previously described with respect to cooler 46.

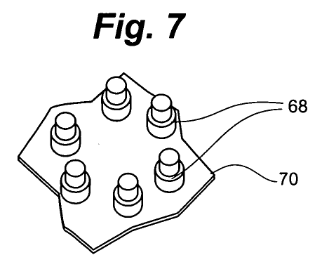

In an alternative embodiment, a plurality of discrete LED's 68 may be mounted in an array or matrix of various configurations on a printed circuit board or a reflective metal plate 70 as shown in FIG. 7. The circuit board or plate 70 may conveniently include any additional components needed for operation of the LED's, such as current-limiting resistors or power supply components. The LED circuit board or plate 70, or a plurality of LED circuit boards or plates, may be positioned to back light a display panel of a vending machine, cooler, beverage dispenser, merchandiser or display rack.

As discussed above, in all of the various embodiments, a reflector may be provided behind the LED arrays to direct more light toward the rear side of the display panel. Alternately, directional LED's may be used for the same purpose.

Most LED's operate on 12 or 24 volts DC, so a suitable power supply is required. The power supply may be located at any convenient position in the cabinet of the vending machine or cooler. The power supply receives line voltage AC from the same source as the vending machine, cooler or beverage dispenser, and outputs 12 or 24 volts DC as required for operation of the LED's.

Control circuitry may also be provided to vary the intensity of the light emitted from the LED arrays, and to control LED's of various colors in the arrays independently to provide color effects on the display panel.

It should be noted that the foregoing relates only to the preferred embodiments of the present invention and that numerous changes and modifications may be made without departing from the spirit and scope of the invention as defined by the following claims.

We claim:

1. A dispensing apparatus for dispensing a plurality of products, comprising:
a housing from which said products are dispensed;
a display panel mounted on said housing; and
an LED positioned behind said display panel to illuminate said display panel.

2. The apparatus of claim 1 further comprising a plurality of LED's.

3. The apparatus of claim 2 wherein the plurality of LED's comprises a linear array.

4. The apparatus of claim 2 wherein the plurality of LED's comprises an array mounted on a circuit board.

5. The apparatus of claim 2 wherein the plurality of LED's comprises an array mounted on a reflective plate.

6. The apparatus of claim 1 further comprising a reflector positioned behind the LED.

7. The apparatus of claim 1 wherein the LED is directional and is positioned to direct light toward the rear of said display panel.

8. The apparatus of claim 1 wherein said apparatus is a vending machine.

9. The apparatus of claim 1 wherein said apparatus is a refrigerated merchandiser.

10. The apparatus of claim 1 wherein said apparatus is a beverage dispenser.

11. A cooler for holding and dispensing a plurality of products, comprising:
a housing;
a refrigerated compartment in said housing for holding said products;
a translucent sign panel; and
a back light assembly including an LED light source for providing back light to the sign panel, means for mounting the back light assembly within the housing, and means for supplying power to said LED light source.

12. The cooler of claim 10 wherein said LED light source comprises a plurality of LED's.

13. The cooler of claim 11 wherein the plurality of LED's comprises a linear array.

14. The cooler of claim 11 wherein the plurality of LED's comprises an array mounted on a circuit board.

15. The cooler of claim 11 wherein the plurality of LED's comprises an array mounted on a reflective plate.

16. The cooler of claim 10 further comprising a reflector positioned behind the LED light source.

17. The cooler of claim 10 wherein the LED light source is directional and is positioned to direct light toward the rear of said translucent sign panel.

18. The cooler of claim 10 wherein said cooler is a vending machine.

19. The cooler of claim 10 wherein said cooler is a refrigerated merchandiser.

20. The cooler of claim 10 wherein said cooler is a beverage dispenser.

21. A method for illuminating a sign panel on a vending machine comprising positioning an LED light source behind said sign panel.
